(19) United States
(12) Patent Application Publication
(10) Pub. No.: US 2014/0269556 A1
(43) Pub. Date: Sep. 18, 2014

(54) SYSTEM AND METHOD FOR UNIT IDENTIFICATION IN A BROADBAND PUSH-TO-TALK COMMUNICATION SYSTEM

(71) Applicant: Mobilesphere Holdings II LLC, Kirkland, WA (US)

(72) Inventor: Robert G. Mechaley, JR., Kirkland, WA (US)

(73) Assignee: Mobilesphere Holdings II LLC, Kirkland, WA (US)

(21) Appl. No.: 14/205,815

(22) Filed: Mar. 12, 2014

Related U.S. Application Data
(60) Provisional application No. 61/782,059, filed on Mar. 14, 2013.

(51) Int. Cl. H04W 76/00

(52) U.S. Cl. CPC H04W 76/005
USPC 370/329

(57) ABSTRACT

A broadband push-to-talk communication system provides identity data to uniquely identify a message sender in a group communication. The individual wireless devices that are part of a group call are each assigned a unique identity, which may be an IP address and/or other identity. When a PTT communication is initiated, the transmitting device transmits identity data in addition to the message. The message and identity data are relayed to each wireless device designated as part of a group call to permit unambiguous identification of the transmitting unit. When the PTT communication is terminated, the group members receive a terminating packet that will delete the sender identity. In addition to identity data, location data and other auxiliary data may also be transmitted to all group members.

### BACKGROUND OF THE INVENTION

1. Field of the Invention

The present invention is directed generally to communication systems and, more particularly, to techniques for identifying a particular unit in a broadband push-to-talk communication system.

2. Description of the Related Art

Public wireless networks, which usually have wide and ubiquitous coverage, can be useful in providing private network-type capabilities. Public networks based on iDEN technology, for example, offer the ability to provide push-to-talk (PTT) capabilities similar to those in a private land mobile two-way network without the cost of building such a network.

There are a number of known systems available to implement a PTT communication system. In one example, the iDEN system remedied the drawbacks of traditional public wireless networks by placing all receiving units for a Group Call in receive mode at the same time. The iDEN network uses a time division technique which divides all communications into slices of time called timeslots. By directing all of the mobile units in a Group Call into a single timeslot containing the communications, all units receive the same communications at the same instant.

A PTT communication system is also known for use in orthogonal frequency division multiple access (OFDMA) systems. U.S. Pat. No. 8,095,163, which is incorporated herein by reference in its entirety, discloses a group communication system in which the wireless devices of all members of a group are all assigned the same subset of subcarriers on the downlink. With this approach, whenever there is a communication to the group, the data is encoded into the subcarriers and transmitted such that all group members receive the message at the same time.

Although group communications are possible with various communication technologies, it is desirable to identify the speaker in a PTT transmission. Therefore, it can be appreciated that there is a significant need for a system and method for user identification in a PTT communication system. The present disclosure is directed to techniques to provide such capability.

### BRIEF DESCRIPTION OF THE SEVERAL VIEWS OF THE DRAWING(S)

FIG. 1 illustrates an exemplary communication architecture used to implement a communication network in accordance with the present teachings.

FIG. 2 illustrates frequency allocation in an orthogonal frequency division multiplexed system.

FIG. 3 is a functional block diagram of a wireless communication device constructed in accordance with the present teachings.

FIG. 4 is a flowchart illustrating the operation of the system of FIGS. 1 and 2.

### DETAILED DESCRIPTION OF THE INVENTION

The present disclosure is directed to techniques for identifying the sender of a communication in a group communication setting. As appreciated by those skilled in the art, a push-to-talk (PTT) system generally involves short duration communications. In these short communications, it can be difficult to determine the identity of the person sending the communication to the group. This is especially true in an emergency situation where ambient noise may interfere with the listener's ability to identify the speaker. In other situations, some member of the group may not be known to all other members and thus the voice may simply by unrecognizable. In accordance with the present teachings, data is transmitted along with the voice message to unambiguously identify the speaker. Although examples are presented herein with respect to certain communication technologies, those skilled in the art will appreciate that the present teachings can be extended to other known forms of group communication.

Orthogonal frequency division multiple access (OFDMA) communication systems utilize a large number of closely-spaced subcarriers to transmit data. The input data is divided into a number of parallel data streams, one for each subcarrier. Each subcarrier is then modulated using a conventional modulation scheme, such as phase shift keying (PSK), quadrature amplitude modulation (QAM), or the like. The subcarriers are orthogonal to each other to prevent intercarrier interference. Those skilled in the art will appreciate that OFDMA technology has developed into a popular communication technique for wideband wireless communication.

As described in U.S. Pat. No. 8,095,163, a set of tones or groups of tones (i.e., subcarrier) are assigned to a particular mobile unit during a call setup process. The assignment of tones to a particular mobile unit during a channel set up operation and the actual communication process between a mobile unit and base station is well known in the art and need not be described in greater detail herein. However, the assignment of the same set of subcarriers to all devices in a communications group enables mobile units utilizing OFDMA technology to be synchronized such that communications in a push-to-talk (PTT) system are received simultaneously by all group members.

The communication techniques are implemented by a system 100 illustrated in FIG. 1. A base station 102 communicates with a plurality of wireless communication devices 108-114 via wireless communication links 118-124, respectively. Thus, the wireless communication devices 108-114 are all within the coverage area of the base station 102. The wireless communication device 114 is also within the coverage area of a base station 104. The wireless communication device 114 can communicate with the base station 104 via a wireless communication link 126. Also illustrated in FIG. 1 is a wireless communication device 116, which communicates with the base station 104 via a wireless communication link 128. The process of assigning OFDMA tones or groups of tones to each of the wireless devices (e.g., the wireless communication device 108) and the actual communication between the wireless communication devices 108-114 and the base station 102 are well-known in the art and need not be described in greater detail herein.

The base station 102 is communicatively coupled to a base station controller 130 via a communication link 132. In a typical embodiment, the base station controller 130 may provide operational control for one or more base stations 102. As illustrated in FIG. 1, the base station 104 is also coupled to the base station controller 130 via a communication link 129. Those skilled in the art will appreciate that a typical wireless communication network will have a large number of base stations that each communicate with a large number of wireless devices. For the sake of clarity, only two base stations (i.e., the base stations 102 and 104) and a few wireless communication devices (i.e., the wireless communication devices 108-116) are illustrated in FIG. 1.

In turn, the base station controller 130 is coupled to a mobile switching center (MSC) 134 via a communication link 136. As is known in the art, the MSC 134 is typically coupled to a large number of base station controllers and is responsible for switching and routing of calls to other base stations and/or a telephone network, such as the public switched telephone network (PSTN) 138.

The MSC 134 may also provide access to a core network 140 via a communication link 142. The core network 140 is the central part of a communication network that may include a number of functions, such as authorization, billing and the like. In addition, the network 140 may provide access to other networks, such as the Internet, for web applications via one or more gateways (not shown).

The MSC 134 is commonly used in circuit-switched networks. For packet-switched networks, a set of equivalent functions may be provided based on TCP/IP and VoIP technologies. The specific form of network elements may vary based on implementation details. However, those skilled in the art will understand that the OFDMA implementation of the present teachings may be applicable to a variety of network architectures.

FIG. 1 is simplified to illustrate the operation of the system 100 with a group of wireless communication devices communicating in proximity with each other. In the illustrated embodiment, the wireless communication devices 108-114 are all communicating with the same base station (i.e., the base station 102). However, those skilled in the art will appreciate that the wireless communication devices 108-114 may communicate with other base stations as well. For example, the wireless communication device 114 is capable of communicating with the base station 102 via the wireless communication link 124 or communicating with the base station 104 via the wireless communication link 126. For the sake of simplicity, FIG. 1 also eliminates a number of conventional network elements, such as gateways, firewalls, and other control elements that are not pertinent to a clear understanding of the present teachings.

In an OFDMA implementation, a plurality of mobile communication devices may be designated for operation in a Group Call function. When individual mobile communication units are designated as part of the same group, the wireless communication devices of that group will all be assigned the same OFDMA tones for communication purposes. FIG. 2 illustrates a number of uplink and downlink timeslots and the designation of the tones to various groups. In the example illustrated in FIG. 2, a group of wireless communication devices (e.g., the wireless communication devices 108-110 are designated as Group1. As illustrated in FIG. 2, the wireless communication devices of Group1 are assigned tones 2, 3, and 5 in downlink timeslots 1 and 3. It should be noted that the assigned tones need not be contiguous. Furthermore, the number of tones assigned to a particular group can vary dynamically based on bandwidth requirements for the particular communication application. That is, simple audio communication may require less bandwidth than other forms of data communication, such as streaming video.

Also illustrated in FIG. 2, is a second set of tones assigned to Group2 (e.g., the wireless communication devices 112-116). In this example, the wireless communication devices of Group2 are assigned tones 9 and 10 in downlink time slots 1, 3, 7, 9, and 11. All wireless communication devices that are in a particular sector, cell, or area that identify it as a member of a certain group will receive a Group Call and are assigned the same set of OFDMA tones within each timeslot on the downlink (those skilled in the art will appreciate that the downlink is conventionally considered the communication from the base station 102 to the wireless communication devices). Thus, in the example described herein, the wireless communication devices 108-110, which are assigned to Group 1 will all have the same OFDMA tones assigned to each mobile unit.

The information for each group is encoded in a conventional fashion using the assigned tones. When the base station transmits the encoded information using the assigned tones for a group, all members in that Call Group will receive the information simultaneously. Thus, the techniques may be used to support a push-to-talk system in an OFDMA communication network.

The concept illustrated herein is shown in FIG. 2 in a very simplified form with a relatively small number of tones assigned to individual ones of the groups (e.g., Group1, Group2, and Group3). However, a typical OFDMA wave form contains hundreds or thousands of tones. This advantageously allows a large number of Group Calls to be supported simply by directing the appropriate wireless communication devices in each group to receive the appropriate tones or sets of tones assigned to that group. Again, FIG. 2 illustrates a simplistic version with only three groups set up with a relatively small number of tones assigned to each group. However, the principles described herein can be extended to a large number of groups.

FIG. 1 illustrates the wireless communication devices (e.g., the wireless communication devices 108-110) in a group (e.g., Group1) as communicating with a single base station. However, the principles of the present disclosure permit group members to be coupled to different base stations. In the example of the SWAT team described above, the actual team members may communicate with a single base station or with multiple base stations if the operational area for the SWAT team is a large geographical area. In addition, a command post, for example, may be established at some distance from the theater of operations. Thus, it is possible that the command post wireless communication device may be in communication with a different base station. In the example of FIG. 1, the wireless communication device 116 may be part of Group1. Even though the wireless communication device 116 communicates with the base station 104, it will receive all communications transmitted to the members of Group1. Those skilled in the art will appreciate that the frequency or subcarrier of the OFDMA tones may differ from the base station 102 to the base station 104. That is, the members of Group1 communicating with the base station 102 may be assigned a first set of OFDMA tones while the members of Group1 communicating with the second base station may be assigned a second set of OFDMA tones that may be the same or different from the first set of OFDMA tones. However, the system 100 can identify members of a group communicating with different base stations as members of the same group even though the different base stations may have assigned different set of OFDMA tones to the respective wireless communication devices communicating therewith. Similarly, wireless communication devices in a single group may be communicating with the same base station, but with a different sector of that base station. In this fashion, all members of a designated group, whether coupled to the same sector or base station or coupled to different sectors or completely different base stations, can still be configured to simultaneously receive communications from other group members.

In accordance with the present teachings, a second group of OFDMA tones may be allocated to provide identification information related to the sender of the present communication. FIG. 2 illustrates identification (ID) tones 1, 6, and 7 in the downlink time slots to provide identification information.

On the uplink, the device activating the PTT button transmits a data packet that includes identification data with the transmitted message. In one embodiment, the data packet includes an Internet Protocol (IP) address and/or the media access control (MAC) address with the message. Alternatively, the data packet may include another unique identifier, such as a user name, device name, the actual user name, or the like. For example, the user ID may be “Unit1, George73, John Doe,” and the like. The extra identification can be in addition to or in place of the IP and/or MAC address.

On the downlink, each unit that is part of the designated group receives the message by decoding the assigned group subcarriers. In addition, each wireless communication unit in the group receives and decodes the designated identification (ID) subcarriers and displays the identifier on a device display.

When the transmitting unit ceases transmission, the unit transmits an end-of-transmission data packet containing the identification data (IP address or other identification) as described above. The end-of-transmission data packet is also retransmitted on a downlink using the designated group subcarriers and ID subcarriers, as described above, the receiving units decode the ID information and remove the displayed identity data.

FIG. 3 is a functional block diagram of an electronic device, such as the wireless communication devices 108-114 in FIG. 1. The device includes a central processing unit (CPU) 148. Those skilled in the art will appreciate that the CPU 148 may be implemented as a conventional microprocessor, application specific integrated circuit (ASIC), digital signal processor (DSP), programmable gate array (PGA), or the like. The wireless communication device 108 is not limited by the specific form of the CPU 148.

The electronic device in FIG. 3 also contains a memory 150. The memory 150 may store instructions and data to control operation of the CPU 148. The memory 150 may include random access memory, ready-only memory, programmable memory, flash memory, and the like. The electronic device is not limited by any specific form of hardware used to implement the memory 150. The memory 150 may also be integrally formed in whole or in part with the CPU 148.

The electronic device of FIG. 3 also includes conventional components, such as a display 152, keypad or keyboard 154 and audio input device 156. The display 152 can be an LED display, LCD, OLED, or the like that is part of the wireless communication device itself or is functionally connected thereto (e.g., a heads-up display). These forms of display are common in conventional wireless communication devices, sometimes referred to as smartphones. The electronic device may also include a video input 158, such as a conventional built-in camera that is common in many wireless electronic devices.

The electronic device of FIG. 3 also includes a transmitter 162 such as may be used by the wireless communication device 108 for normal wireless communication with the base station 102 (see FIG. 1). FIG. 3 also illustrates a receiver 164 that operates in conjunction with the transmitter 162 to communicate with the base station 102. In a typical embodiment, the transmitter 162 and receiver 164 are implemented as a transceiver 166. The transceiver 166 is connected to an antenna 168. Operation of the transceiver 166 and the antenna 168 is well-known in the art and need not be described in greater detail herein.

The wireless communication device in FIG. 23 also includes a push-to-talk (PTT) processor 170. The PTT processor 170 controls operation of the wireless communication device in a Group Call mode. The PTT processor 170 includes a PTT button (not shown) which, when activated by the user, places the device in a transmit mode such that outgoing communications from the PTT activated device will be transmitted, via the base station 102, to the wireless communication devices of the other group members. Alternatively, the PTT processor 170 may comprise a voice operated relay (VOX). In this embodiment, the PTT processor 170 monitors the audio input 156 to detect an onset of audio input from the user. In a VOX implementation, the PTT processor 170 can also include circuitry to avoid inadvertent activation of the transmitter 162. For example, transient noises can be filtered out by the PTT processor 170. Thus, the PTT processor 170 can look at the rise time and/or duration of the audio signal at the audio input 156 to determine whether or not to activate the VOX circuitry.

Those skilled in the art will recognize that the PTT processor 170 may be implemented as a series of computer instructions stored in the memory 150 and executed by the CPU 148. However, the PTT processor 170 is shown as a separate block in the functional block diagram of FIG. 3 because it performs a separate function.

The various components illustrated in FIG. 3 are coupled together by a bus system 172. The bus system may include an address bus, data bus, power bus, control bus, and the like. For the sake of convenience, the various busses in FIG. 3 are illustrated as the bus system 172.

The operation of the system 100 is illustrated in the flow chart of FIG. 4. At a start 200, the wireless communication devices are powered up. As noted above, each wireless communication device has a unique IP and MAC address and may have another identity, as described above. At step 202, the system 100 performs a call setup operation. The call setup process in step 202 includes the assignment of free OFDMA tones for use in group communication as well as the assignment of OFDMA tones for the ID data. In a typical group call arrangement, once a group call is set up, it is usually maintained for some predetermined or reserved time that is renewed each time a member of the group continues to communicate. If the predetermined or reserved period of time lapses with no group communication, the resources may be released and a call tear-down process initiated. Alternatively, it is possible to perform a call set-up and tear-down operation each time a PTT button (or VOX circuitry) is activated by one of the group members. While the latter process may free OFDMA tones for use in between communications by other users, there may be added overhead to set up and tear down the call each time a PTT button is depressed. As those skilled in the art will appreciate, each time the call is set up, the OFDMA tone or tones must be assigned to all group members. However, the present disclosure is intended to encompass either method.

During the course of the communication, additional group members may be added. The call set up process described in step 202 above may be applied to additional wireless communication devices. If the additional wireless communication device is to be added to a group (e.g. Group1), that wireless communication device is assigned the same group of OFDMA tones and ID tones previously assigned to Group1.

In step 204, one of the wireless communication devices detects PTT operation. As noted above, PTT operation may be manually initiated by depressing a PTT button on the wireless communication device or automatically activated, such as the VOX example described above.

In response to the detection of PTT operation, the wireless communication device initiating the communication will upload the ID data and message in step 206. As described above, the ID data will include the IP address, MAC address and/or different unique identity data as described above. In addition, the transmitting device can transmit additional data, such as location information. Those skilled in the art will appreciate that such location information could be valuable in an emergency communication setting, such as a fire fighting operation. The location data may be determined using one of more conventional location technologies (e.g., GPS data, triangulation data, signal strength data, and the like). The present disclosure is not limited by the particular form in which the location data may be derived or transmitted by the wireless communication device.

The message is transmitted to the base station and relayed to all other group members in the manner described above. If group members are connected to other base stations (e.g., the base station 104), the message is relayed through the communications system backhaul from the base station 102 to the base station 104 for transmission to group members coupled to that base station.

If sufficient spectral resources are available, the system 100 can assign a different set of OFDMA tones to use on the uplink for each of the wireless communication devices within a group. This is referred to as a contention-free uplink because each of the wireless communication devices has an independent uplink to the base station (e.g., the base station 102). The base station receives a message and identity data on the uplink from one of the wireless communication devices and relays that message and identity data to all of the group members in the manner described above. If multiple wireless communication devices send messages to one or more base stations on their respective uplinks, the system 100 can digitally mix the multiple uplink messages and transmit the combined messages on the shared downlink. This effectively provides a conference call between group members where one or more persons may speak at the same time.

Alternatively, if resources are scarce, it is possible to use a contention-based system in which group members must compete for available time on the uplink. If group members attempt to communicate simultaneously, the base station controller detects the collision and signals back to the wireless communication units in the group and a lock out tone is generated. The lock out tone alerts the users that simultaneous access attempts were made and that users should listen before talking and pace their access attempts. Because the collision detection and lock out tone generation happens so quickly, it appears that the lock out tone is generated as the user presses the push-to-talk-button on the wireless communication device.

On the downlink, the base station (e.g., the base station 102) transmits data using an assigned set of OFDMA message tones and ID tones in step 208. Because each of the wireless communication devices in the designated group has identical sets of OFDMA message tones and ID tones assigned for the downlink, each group member will receive downlink communications simultaneously. In step 210, each wireless communication device in the group receives the ID data and message. In step 210, the ID of the sender is displayed on the display 152 (see FIG. 3) of each receiving wireless communication device. The display can also show data associated with the identity, such as a picture of the sender, map location, rank, role, and the like. The map location can pinpoint the location of the message sender on a map shown on the display 152. In step 212, each wireless communication device in the group also receives the message data and decodes and plays the message data in a conventional fashion.

In decision 214, the system determines if the PTT button has been released. If the PTT button is not released, the result of decision 214 is NO and the process returns to step 206 to continue conducting communications.

If the PTT button is released (or the VOX deactivated), the result of decision 214 is YES and, in step 216, the system performs a PTT termination process. As soon as the PTT processor 170 (see FIG. 3) detects the release of the PTT button, it sends a final data packet indicating the termination of the present communication along with the identity data. That message is relayed to all of the group members in the manner described above with respect to the regular communications. As each wireless communication device in the group receives the termination message, it deletes the identity from the display 152.

As described above, the group communication can reserve the set of OFDMA message tones and ID tones for a prolonged period of time or may release the reserved tones when the PTT button is released. In the latter embodiment, the call setup, with the assignment of OFDMA message tones and ID tones is performed after the detection of PTT operation in step 204.

In the former embodiment, the call setup in step 202 is performed in an initial operation to establish the group communication. The assigned OFDMA message tones and ID tones are reserved for the duration of the group communication. At the end of the group communication, the system performs a call tear-down process. Those skilled in the art will appreciate that the call tear down process may vary depending on the particular communication technology. In OFDMA technology, the tear down process includes the de-selection of any tones that were previously assigned for the group message or for the ID data that frees the resources for other network operations. The process ends at 218.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. An OFDM communication system, comprising:
a plurality of wireless communication devices, each having:
a receiver configured to receive data from a base station, each of the plurality of wireless communication devices having designated data communication OFDM tones in a downlink timeslot for data communication and a plurality of separate identification (ID) OFDM tones in the downlink timeslot for message sender identification data wherein the receiver in each of the plurality of wireless communication devices decodes the designated ID OFDM tones to thereby determine an identifier related to an identity of a sender of an incoming message;
a transmitter configured to transmit data to the base station; and
a push-to-talk (PTT) processor to control communications, the PTT processor, when activated, being configured to cause the transmitter to transmit a message from a sender to others of the plurality of wireless communications devices via the base station, the message including the identifier.

2. The system of claim 1, further comprising a voice-activated circuit coupled to the PTT processor wherein the PTT processor is activated by the voice-activated circuit.

3. The system of claim 1 wherein the identifier comprises an IP address.

4. The system of claim 1 wherein the identifier comprises a MAC address.

5. The system of claim 1 wherein the identifier comprises user-selected identification data.

6. The system of claim 1 wherein the identifier comprises at least one identifier selected from a group of identifiers comprising an IP address, a MAC address, a picture of the sender of the incoming message, a rank of the sender of the incoming message, and a role of the sender of the incoming message.

7. The system of claim 1 wherein the identifier includes location data for the sender of the incoming message.

8. The system of claim 7, further comprising a display in each of the plurality of wireless communication devices wherein the location data for the sender of the incoming message is shown on the display in a map form.

9. The system of claim 1 wherein each of the plurality of wireless communication devices is assigned the same set of designated data communications OFDM tones for use on the downlink whereby each of the plurality of wireless communication devices receives the same communication data on the downlink as a Group Call function, the PTT processor being further configured to cause the transmitter to transmit the identifier on the downlink with the communication data.

10. The system of claim 1, further comprising a display in each of the plurality of wireless communication devices wherein the identifier is shown on the display.

11. The system of claim 1 wherein deactivation of the PTT processor causes the transmitter to send an ending transmission message containing the identifier.

12. A method for communication by a plurality of wireless communication devices in an OFDM communication system with each of the plurality of wireless communication devices having a transmitter and a receiver, the method comprising:
a first of the plurality of wireless communication devices initiating a communication with the others of the plurality of wireless communication devices with
each of the plurality of wireless communication devices having designated data communication OFDM tones in a downlink timeslot for data messaging and a plurality of separate identification (ID) OFDM tones in the downlink timeslot for message sender identification data;
the first of the plurality of wireless communication devices transmitting message sender identification data to a base station along with a data message;
the base station transmitting the data message to the others of the plurality of wireless communication devices using the designated data communication OFDM tones in the downlink timeslot for data messaging;
the base station transmitting the message sender identification data to the others of the plurality of wireless communication devices using the designated ID OFDM tones in the downlink timeslot for message sender identification data;
the receiver in each of the others of the plurality of wireless communication devices decoding the designated data communication OFDM tones to thereby detect an incoming message; and
the receiver in each of the others of the plurality of wireless communication devices decoding the designated ID OFDM tones to thereby determine an identifier of the sender of the incoming message.

13. The method of claim 12, further comprising a push-to-talk (PTT) processor in the first of the plurality of wireless communication devices that transmits the message sender identification data to the base station along with the data message when activated.

14. The method of claim 13, further comprising a voice-activated circuit coupled to the PTT processor wherein the PTT processor is activated by the voice-activated circuit.

15. The method of claim 12 wherein the identifier comprises an IP address.

16. The method of claim 12 wherein the identifier comprises a MAC address.

17. The method of claim 12 wherein the identifier comprises user-selected identification data.

18. The method of claim 12 wherein the identifier comprises at least one identifier selected from a group of identifiers comprising an IP address, a MAC address, a picture of the sender of the incoming message, a rank of the sender of the incoming message, and a role of the sender of the incoming message

19. The method of claim 12 wherein the identifier includes location data for the sender of the incoming message.

20. The method of claim 19, further comprising displaying the location data for the sender of the incoming message on a display in a map form.

21. The method of claim 12, further comprising assigning the same set of designated data communications OFDM tones to each of the plurality of wireless communication devices for use on the downlink whereby each of the plurality of wireless communication devices receives the same communication data on the downlink as a Group Call function.

22. The method of claim 12, further comprising displaying the identifier on a display of each of the plurality of wireless communication devices.

23. The method of claim 12, further comprising sending an ending transmission message containing the identifier when the first of the plurality of wireless communication devices stops transmitting.
